(19) United States
(12) Patent Application Publication
(10) Pub. No.: US 2024/0275455 A1
(43) Pub. Date: Aug. 15, 2024

(54) BEAM MANAGEMENT USING MULTIPLE CHANNEL STATE INFORMATION REFERENCE SIGNAL RESOURCE CONFIGURATIONS

(71) Applicant: QUALCOMM Incorporated, San Diego, CA (US)

(72) Inventors: Hung Dinh LY, San Diego, CA (US); Yan ZHOU, San Diego, CA (US)

(21) Appl. No.: 18/529,613

(22) Filed: Dec. 5, 2023

Related U.S. Application Data
(60) Provisional application No. 63/485,160, filed on Feb. 15, 2023.

(51) Int. Cl. H04B 7/06; H04L 5/00; H04W 16/28

(52) U.S. Cl. CPC H04B 7/0626; H04B 7/06952; H04L 5/0051; H04W 16/28

(57) ABSTRACT

Various aspects of the present disclosure generally relate to wireless communication. In some examples, the described techniques can be used to perform beam management procedures using a selected configuration of a plurality of configurations, which enables adaptation to changing numbers of channel state information reference signal (CSI-RS) resources. Adapting to changing numbers of CSI-RS resources may enable the network to perform dynamic antenna adaptation, thereby changing the number of active spatial elements used to transmit the CSI-RS resources. Furthermore, signaling the selected configuration enables the network node to change the number of CSI-RS resources at a user equipment (UE) without explicitly reconfiguring the CSI-RS resource set. In some aspects, the UE may determine a configuration including a number of CSI-RS resources using a mapping between the configuration and a configuration of a number of CSI-RS resources for CSI measurement, which enables the UE to determine the selected configuration.

### CROSS-REFERENCE TO RELATED APPLICATION

This Patent Application claims priority to U.S. Provisional Patent Application No. 63/485,160, filed on Feb. 15, 2023, entitled “BEAM MANAGEMENT USING MULTIPLE CHANNEL STATE INFORMATION REFERENCE SIGNAL RESOURCE CONFIGURATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for beam management using multiple channel state information reference signal (CSI-RS) resource configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A UE and a network node (which may be a base station or a component of a disaggregated base station) may communicate using beamforming. Beam management is the process of identifying a suitable beam pair, including a beam at the UE and a beam at the network node, for beamformed communication. Beam management may involve the transmission of reference signals by the network node and the measurement of these reference signals at different stages, described in more detail elsewhere herein. Generally, the spatial characteristics of a beam are related to the number of antenna elements (sometimes referred to as spatial elements) used to generate the beam. For example, a beam generated using a larger number of antenna elements may be expected to be narrower (that is, covering a smaller area at a higher gain) than a beam generated using a smaller number of antenna elements. The number of active antenna elements used for transmission or reception of a signal can change for various reasons, such as due to dynamic antenna adaptation, which is also described in more detail elsewhere herein.

### SUMMARY

Some aspects described herein relate to a method of wireless communication performed by a user equipment (UE). The method may include transmitting information indicating one or more supported numbers of channel state information reference signal (CSI-RS) resources per CSI-RS resource set. The method may include receiving configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The method may include performing at least part of a beam management procedure in accordance with the configuration information.

Some aspects described herein relate to a method of wireless communication performed by a network node. The method may include receiving information indicating one or more supported numbers of CSI-RS resources per CSI-RS resource set for a UE. The method may include transmitting configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The method may include performing at least part of a beam management procedure in accordance with the configuration information.

Some aspects described herein relate to a non-transitory computer-readable medium that stores a set of instructions for wireless communication by a UE. The set of instructions, when executed by one or more processors of the UE, may cause the UE to transmit information indicating one or more supported numbers of CSI-RS resources per CSI-RS resource set. The set of instructions, when executed by one or more processors of the UE, may cause the UE to receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The set of instructions, when executed by one or more processors of the UE, may cause the UE to measure a CSI-RS in accordance with the configuration information.

Some aspects described herein relate to a non-transitory computer-readable medium that stores a set of instructions for wireless communication by a network node. The set of instructions, when executed by one or more processors of the network node, may cause the network node to receive information indicating one or more supported numbers of CSI-RS resources per CSI-RS resource set for a UE. The set of instructions, when executed by one or more processors of the network node, may cause the network node to transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The set of instructions, when executed by one or more processors of the network node, may cause the network node to perform at least part of a beam management procedure in accordance with the configuration information.

Some aspects described herein relate to an apparatus for wireless communication. The apparatus may include means for transmitting information indicating one or more supported numbers of CSI-RS resources per CSI-RS resource set. The apparatus may include means for receiving configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The apparatus may include means for performing at least part of a beam management procedure in accordance with the configuration information.

Some aspects described herein relate to an apparatus for wireless communication. The apparatus may include means for receiving information indicating one or more supported numbers of CSI-RS resources per CSI-RS resource set for a UE. The apparatus may include means for transmitting configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The apparatus may include means for performing at least part of a beam management procedure in accordance with the configuration information.

Some aspects described herein relate to a UE for wireless communication. The UE may include at least one memory and at least one processor communicatively coupled with the at least one memory. The at least one processor may be operable to cause the UE to transmit information indicating one or more supported numbers of CSI-RS resources per CSI-RS resource set. The at least one processor may be operable to cause the UE to receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The at least one processor may be operable to cause the UE to measure a CSI-RS in accordance with the configuration information.

Some aspects described herein relate to a network node for wireless communication. The network node may include at least one memory and at least one processor communicatively coupled with the at least one memory. The at least one processor may be operable to cause the network node to receive information indicating one or more supported numbers of CSI-RS resources per CSI-RS resource set for a UE. The at least one processor may be operable to cause the network node to transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The at least one processor may be operable to cause the network node to perform at least part of a beam management procedure in accordance with the configuration information.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating examples of channel state information (CSI) reference signal beam management procedures, in accordance with the present disclosure.

FIG. 5 is a diagram illustrating an example of dynamic network-side antenna adaptation in accordance with the present disclosure.

FIG. 6 is a diagram illustrating an example of signaling for CSI report configuration with dynamic antenna adaptation, in accordance with the present disclosure.

FIG. 7 is a flowchart illustrating an example process performed, for example, by a UE that supports CSI reporting in accordance with the present disclosure.

FIG. 8 is a flowchart illustrating an example process performed, for example, by a network node that supports CSI configuration in accordance with the present disclosure.

FIG. 9 is a diagram of an example apparatus for wireless communication that supports beam management in accordance with the present disclosure.

FIG. 10 is a diagram of an example apparatus for wireless communication that supports CSI transmission in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to beam management in the context of a changing number of channel state information reference signal (CSI-RS) resources (which may correspond to a changing number of spatial elements at a transmitter or receiver of the CSI-RS). Some aspects more specifically relate to user equipment (UE) signaling of one or more supported numbers of CSI-RS resources per CSI-RS resource set, and network configuration of one or more configurations of CSI-RS resources for the CSI-RS resource set in accordance with the signaling. In some aspects, the network may signal a selected one of the one or more configurations, such that the UE can perform a beam management procedure using the selected configuration. Thus, the network can change the number of CSI-RS resources used to generate and measure a CSI-RS without explicitly reconfiguring the UE's CSI-RS resource set or CSI-RS report configuration.

Particular aspects of the subject matter described in this disclosure can be implemented to realize one or more of the following potential advantages. In some examples, the described techniques can be used to perform beam management procedures using a selected configuration of a plurality of configurations, which enables adaptation to changing numbers of CSI-RS resources. Adapting to changing numbers of CSI-RS resources may enable the network to perform dynamic antenna adaptation, thereby changing the number of active spatial elements used to transmit the CSI-RS resources, which saves power at the network node. Furthermore, signaling the selected configuration enables the network node to change the number of CSI-RS resources at the UE without explicitly reconfiguring the CSI-RS resource set, which reduces overhead. In some aspects, the UE may determine a configuration including a number of CSI-RS resources using a mapping between the configuration and a configuration of a number of CSI-RS resources for CSI measurement, which enables the UE to determine the selected configuration in the absence of explicit signaling indicating the selected configuration, which reduces latency relative to explicit signaling of the selected configuration.

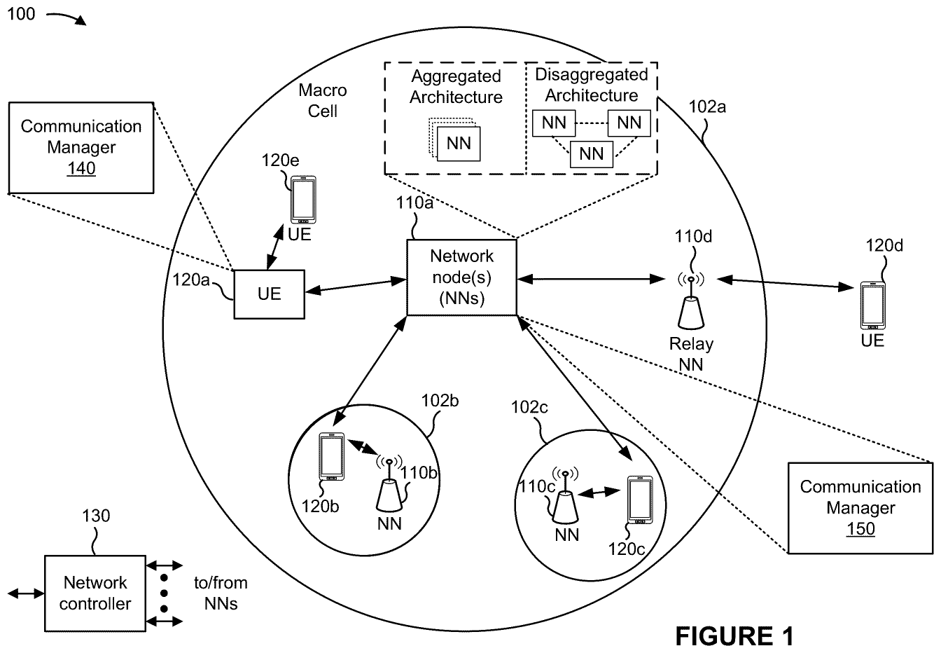

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit information indicating one or more supported numbers of channel state information reference signal (CSI-RS) resources per CSI-RS resource set; receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and measure a CSI-RS in accordance with the configuration information. Additionally or alternatively, the communication manager 140 may perform one or more other operations described herein.

In some aspects, the network node 110 may include a communication manager 150. As described in more detail elsewhere herein, the communication manager 150 may receive information indicating one or more supported numbers of CSI-RS resources per CSI-RS resource set for a UE; transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and perform at least part of a beam management procedure in accordance with the configuration information. Additionally or alternatively, the communication manager 150 may perform one or more other operations described herein.

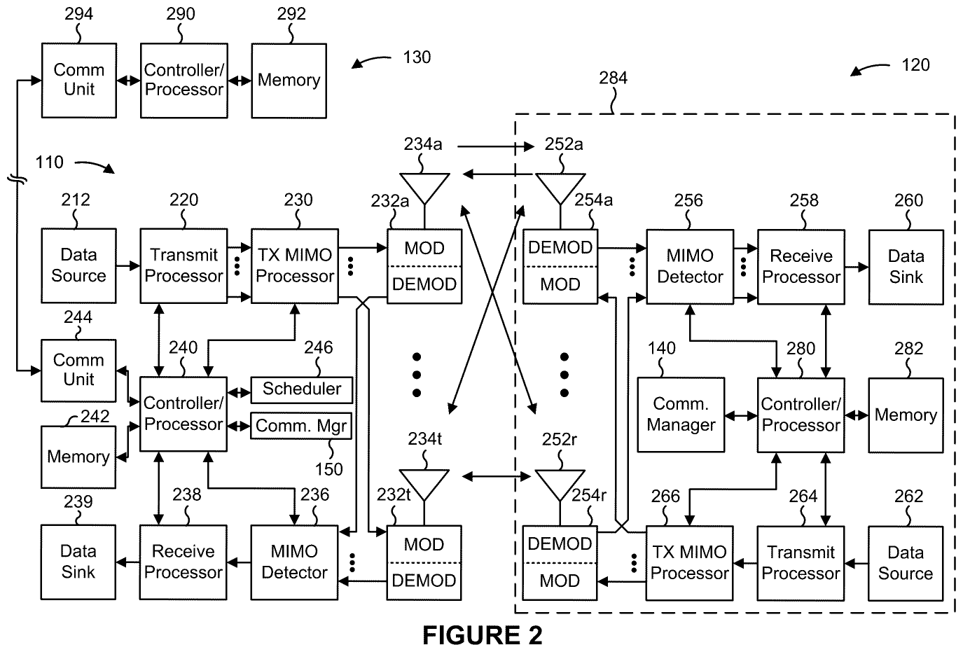

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T>1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

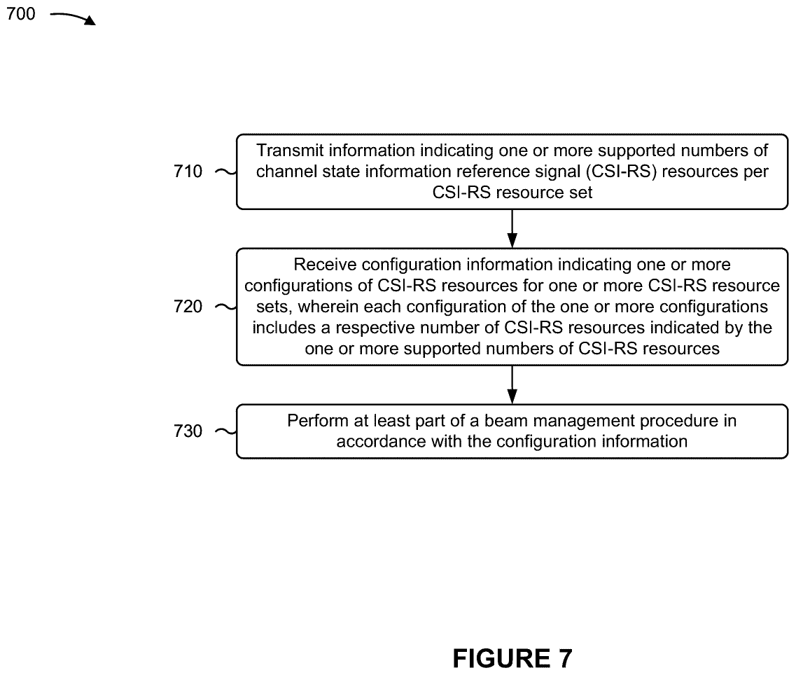

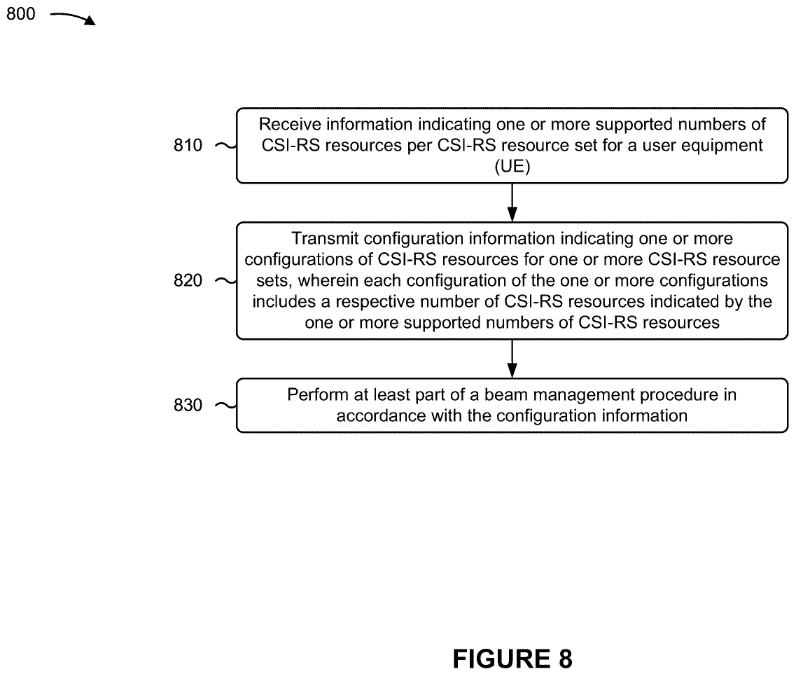

The controller/processor 240 of the network node 110, the controller/processor 280 of the UE 120, or any other component(s) of FIG. 2 may perform one or more techniques associated with CSI-RS reporting, as described in more detail elsewhere herein. For example, the controller/processor 240 of the network node 110, the controller/processor 280 of the UE 120, or any other component(s) of FIG. 2 may perform or direct operations of, for example, process 800 of FIG. 8, process 700 of FIG. 7, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 700 of FIG. 7, or other processes as described herein. In some examples, executing instructions may include running the instructions, converting the instructions, compiling the instructions, or interpreting the instructions, among other examples.

In some aspects, the UE 120 includes means for transmitting information indicating one or more supported numbers of CSI-RS resources per CSI-RS resource set; means for receiving configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; or means for performing at least part of a beam management procedure in accordance with the configuration information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving information indicating one or more supported numbers of CSI-RS resources per CSI-RS resource set for a UE; means for transmitting configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; or means for performing at least part of a beam management procedure in accordance with the configuration information. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

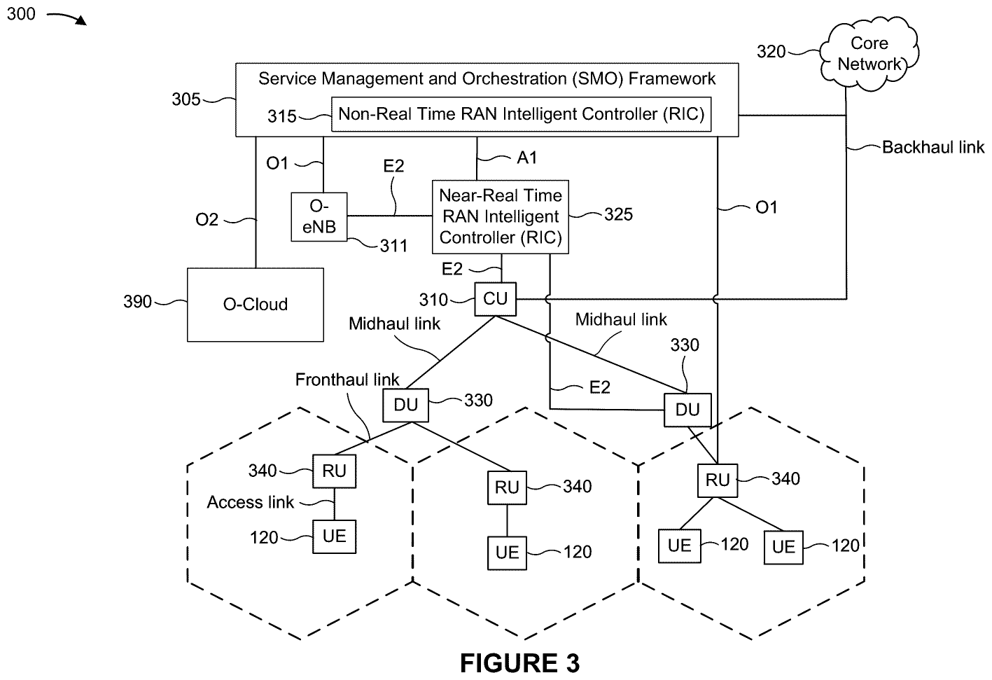

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), or control plane functionality (for example, Central Unit—Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on or otherwise associated with a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

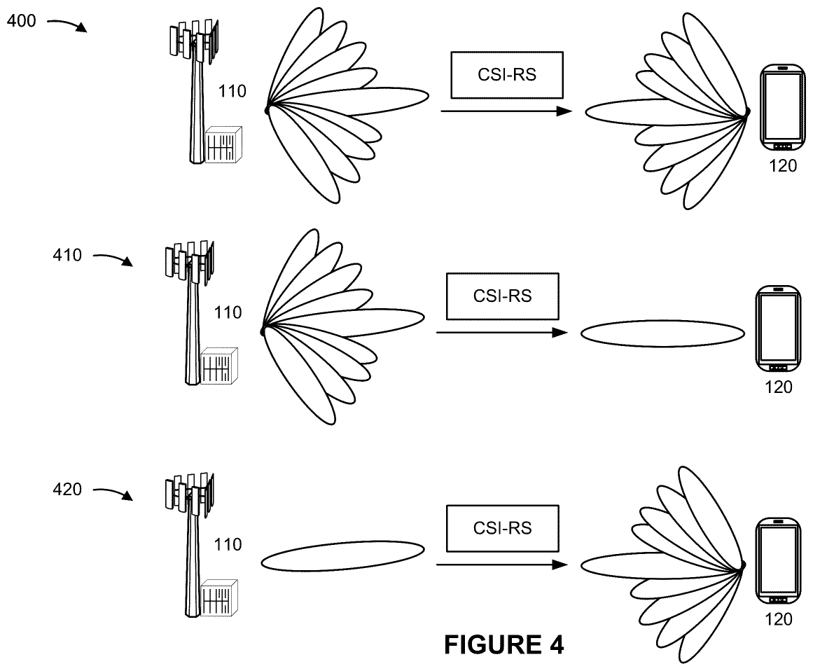

FIG. 4 is a diagram illustrating examples 400, 410, and 420 of CSI-RS beam management procedures, in accordance with the present disclosure. Reference herein to a beam management procedure can include any one or more of the operations described with regard to FIG. 4. As shown in FIG. 4, examples 400, 410, and 420 include a UE 120 in communication with a network node 110 in a wireless network (for example, wireless network 100). However, the devices shown in FIG. 4 are provided as examples, and the wireless network may support communication and beam management between other devices (for example, between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (for example, an RRC connected state).

As shown in FIG. 4, example 400 may include a network node 110 (for example, one or more network node devices such as an RU, a DU, and/or a CU, among other examples) and a UE 120 communicating to perform beam management using CSI-RSs. Example 400 depicts a first beam management procedure (for example, P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (for example, using RRC signaling), semi-persistent (for example, using media access control (MAC) control element (MAC-CE) signaling), and/or aperiodic (for example, using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (for example, with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

The P1 CSI-RS beam management may be referred to as transmit beam selection, and may be used to enable UE measurement on different Tx beams to support selection of gNB Tx beams and UE Rx beam(s). For the network node 110, the P1 CSI-RS beam management may typically include a Tx beam sweep from a set of different beams. For the UE 120, the P1 CSI-RS beam management may typically include signal strength (Layer 1 reference signal received power (RSRP) (L1-RSRP)) measurement and Rx beam sweep from a set of different beams.

As shown in FIG. 4, example 410 may include a network node 110 and a UE 120 communicating to perform beam management using CSI-RSs. Example 410 depicts a second beam management procedure (for example, P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (for example, using DCI). The second beam management procedure may include the network node 110 performing beam sweeping over one or more transmit beams. The one or more transmit beams may be a subset of all transmit beams associated with the network node 110 (for example, determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (for example, a same) receive beam (for example, determined based at least in part on measurements performed in connection with the first beam management procedure). The second beam management procedure may enable the network node 110 to select a best transmit beam based at least in part on measurements of the CSI-RSs (for example, measured by the UE 120 using the single receive beam) reported by the UE 120.

The P2 CSI-RS beam management may include transmit beam refinement, which may enable UE measurement on different transmit beams from a possibly smaller set of beams compared to the P1 CSI-RS beam management. The network node 110 may transmit CSI-RS with different transmit beams. Typically, the UE 120 may measure the Tx beams without receive beam sweep. The UE 120 may report an index (CRI) and signal strength (L1-RSRP) for one or more strongest beams.

As shown in FIG. 4, example 420 depicts a third beam management procedure (for example, P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (for example, using DCI). The third beam management process may include the network node 110 transmitting the one or more CSI-RSs using a single transmit beam (for example, determined based at least in part on measurements reported by the UE 120 in connection with the first beam management procedure or the second beam management procedure). To enable the UE 120 to perform receive beam sweeping, the network node may use a transmit beam to transmit (for example, with repetitions) CSI-RS at multiple times within the same RS resource set so that UE 120 can sweep through one or more receive beams in multiple transmission instances. The one or more receive beams may be a subset of all receive beams associated with the UE 120 (for example, determined based at least in part on measurements performed in connection with the first beam management procedure or the second beam management procedure). The third beam management procedure may enable the network node 110 and/or the UE 120 to select a best receive beam based at least in part on reported measurements received from the UE 120 (for example, of the CSI-RS of the transmit beam using the one or more receive beams).

The P3 CSI-RS beam management may provide receive beam refinement to enable UE measurement on the same gNB transmit beam using changing UE receive beams. A CSI-RS with a common transmit beam may be transmitted in quick succession. The UE 120 may select a receive beam by measuring the CSI-RS, and may not report any measurement results to the network node 110. Generally, P3 beam management may not involve reporting to the network.

In some cases, the on/off capabilities may be associated with a logical antenna port associated with a plurality of transmit receive units (TxRUs) (such as TxRU1, TxRU2, and TxRU3), and the logical antenna port may be turned on or off. This may be referred to as Type 1 spatial domain (SD) adaptation. In Type 1 SD adaptation, a TxRU can be activated or deactivated. In some other cases, referred to as Type 2 SD adaptation, the configuration of physical antenna elements for CSI-RS or physical downlink shared channel (PDSCH) is adapted. This type of adaptation may be useful for FR2, where the number of TxRUs at the network node is limited (such as 1 or 2 TxRUs). In Type 2 SD adaptation, the number of logical antenna ports may remain unchanged while the number of physical antenna elements can be adapted, hence impacting beamforming gain.

In some cases, such as from a CSI perspective, Type 1 SD adaptation may be the adaptation of antenna ports or transceiver chains at network node. In contrast, Type 2 SD adaptation may be the adaptation of transmission power offset values between CSI-RS and SSB.

In some cases, one non-zero power (NZP) CSI-RS resource configuration for channel measurement within one resource setting corresponding to more than one spatial adaptation pattern may be supported. A spatial adaptation pattern may indicate a set of antenna elements or logical antenna ports to be activated or deactivated. In some cases, a resource set with multiple resources may be configured within a resource setting, where each resource is associated with only one spatial adaptation pattern. In some other cases, for a resource configured in a resource set within a resource setting, the resource can be associated with more than one spatial adaptation pattern. One or more resources can be configured in the resource set for channel measurement. In some cases, one CSI report configuration may include multiple CSIs report sub-configurations, where each sub-configuration corresponds to a single spatial adaptation pattern. For a sub-configuration of a CSI report configuration, the UE 120 may be configured with a port subset indication (e.g., a bitmap). The UE 120 may derive a reduced NZP CSI-RS resource from the corresponding NZP CSI-RS resource configured in the CSI-RS resource set of channel management. Configurations of CSI-RS resources and CSI-RS port configurations, including reduced configurations corresponding to spatial adaptation patterns, are described elsewhere herein. The reduced NZP CSI-RS resource may be referred to as a number of CSI-RS resources per CSI-RS resource set.

In some cases, for a CSI report configuration, for each sub-configuration for Type 1 SD adaptation, at least the following may be included: one or more parameters in a codebook configuration (CodebookConfig), and a port subset indication or resource grouping. The one or more parameters in the codebook configuration may include, for example, n1-n2, and ng for multi-panel. In some cases, the one or more parameters may also include a rank restriction, a codebook subset restriction, and/or supported codebook types for a PMI (e.g., Type-I or Type-II). The port subset indication or resource grouping may indicate, for example, a report quantity, a report frequency configuration (reportFreqConfiguration), and/or whether it is explicitly provided or can also be derived (e.g., from the CodebookConfig and/or from the CSI-RS resource configuration). For a CSI report configuration, at least the following can be included for each sub-configuration for Type 2 SD adaptation: an NZP CSI-RS resource set for channel measurement, where different resources can have different power offsets between a CSI-RS and SSB. In some cases, a report quantity can also be included.

In one example, a CSI report configuration for Type 1 SD adaptation in accordance with a port subset indication may have three sub-configurations. The CSI report configuration may have a 32-port NZP CSI-RS resource set (for channel measurement). A first sub-configuration (sub-configuration 1) may have a first spatial adaptation pattern (spatial adaptation pattern 1) and may have a first codebook configuration (codebook configuration 1) with (N1, N2)=(8, 2). A second sub-configuration (sub-configuration 2) may have a second spatial adaptation pattern (spatial adaptation pattern 2) and may have a second codebook configuration (codebook configuration 2) with (N1, N2)=(8, 1). Additionally, the second sub-configuration may have 16-port NZP CSI-RS resource(s), where each resource is a subset of a 32-port CSI-RS resource in a CSI-RS resource set and corresponds to a uniform linear array (ULA) with (N1, N2) in codebook 2. A third sub-configuration (sub-configuration 3) may have a third spatial adaptation pattern (spatial adaptation pattern 3) and may have a third codebook configuration (codebook configuration 3) with (N1, N2)=(4, 1). The third sub-configuration may have 8-port NZP CSI-RS resource(s), where each resource is a subset of a 32-port CSI-RS resource in a CSI-RS resource set and corresponds to a ULA with (N1, N2) in codebook 3. In some cases, the resource subset may be determined based at least in part on a port subset indication.

In another example, a CSI report configuration for Type 1 SD adaptation, in accordance with resource grouping may have three sub-configurations. The CSI report configuration may have a 32-port NZP CSI-RS resource set (for channel measurement). A first sub-configuration (sub-configuration 1) may have a first spatial adaptation pattern (spatial adaptation pattern 1) and may have a first codebook configuration (codebook configuration 1) with (N1, N2)=(8, 2). A second sub-configuration (sub-configuration 2) may have a second spatial adaptation pattern (spatial adaptation pattern 2) and may have a second codebook configuration (codebook configuration 2) with (N1, N2)=(8, 1). Additionally, the second sub-configuration may have a 16-port NZP CSI-RS resource set for channel measurement. A third sub-configuration (sub-configuration 3) may have a third spatial adaptation pattern (spatial adaptation pattern 3) and may have a third codebook configuration (codebook configuration 3) with (N1, N2)=(4, 1). Additionally. the third sub-configuration may have an 8-port NZP CSI-RS resource set for channel measurement. In some cases, there may be no relationship between the resources in the different sub-configurations.

The receive beam sweep component of P1 beam management may be performed as a background process by the UE 120. Due to the analog beamforming restriction, the receive beam sweep could interrupt the PDSCH reception, so it is beneficial if the network node 110 configures designated signals in the form of a CSI-RS repeated with the same beamforming to initiate the P3 beam management process to support receive beam sweeping by the UE 120. For beam reporting purposes, the UE 120 may report the index of the best beams in the form of a CSI-RS resource indicator (CRI) or a synchronization signal/physical broadcast channel (SS/PBCH) block resource index (SSBRI). The UE 120 may also report signal strength measurements in the form of an L1-RSRP value for the indicated beams. When multiple beams are reported, then an absolute RSRP may be reported for the strongest beam (with highest L1-RSRP) and differential RSRP values may be reported for the other beams.

CSI measurement at the UE 120 may be performed according to a configuration of a CSI-RS resource set (which may be indicated by a configuration NZP-CSI-RS-ResourceSet), which may be configured in association with a CSI report configuration that the network has indicated should be used for CSI measurement and reporting. A CSI-RS resource set may be configured with a set of CSI-RS resources (e.g., pointing to indexes “NZP-CSI-RS-ResourceID” of the set of CSI resources). When CSI-RS is used for beam management, and when repetition in NZP-CSI-RS-ResourceSet is set to “off”, a set of CSI-RS resources of a CSI-RS resource set can be configured, each CSI-RS resource being configured with one or two ports. Within the CSI-RS resource set, all resources may have the same number of ports. In this context, each CSI-RS resource typically corresponds to a different transmit beam direction from the network node 110. When receiving these signals, the UE 120 can be configured with a report quantity (such as by a parameter reportQuantity of the CSI-RS resource set) set to “cri-RSRP”. This indicates that the UE 120 is expected to measure L1-RSRP (which is the CSI-RS power on the CSI-RS port if a single port is used, or the average power across two ports if two ports are used) and to report a CSI-RS resource index (CRI) of the strongest CSI-RS resources (although selecting the strongest CSI-RS resources to report is not a requirement, and the UE is allowed to use other selection criteria as well) within the configured CSI-RS resource set, together with their power (L1-RSRP) sorted in descending order.

When CSI-RS is used for beam management and repetition in NZP-CSI-RS-ResourceSet is set to “on”, the CSI-RS may be used for receive beam sweeping using two or more different spatial receive filters at the UE 120. In this case, multiple configured CSI-RS resources have the same transmit beam direction (that is, a CSI-RS is transmitted on the multiple configured CSI-RS resources using a same spatial transmit filter at the network node 110). The UE 120 can vary the analog beamforming direction in the UE 120's receiver (using spatial receive filters) and compare the signal strength of the different directions. The receive direction with the strongest received signal can be used subsequently for receiving other signals from the same transmit beam direction. This may be considered a transparent operation in that the UE 120 is not expected to report measurement results to the network node 110. Note that when repetition is set to “on”, there are no actual repetition parameters configured. The repetition indicates that the resources within the resource set have the same repeated transmit beam direction to make the UE's receive beam sweeping operation meaningful.

Other examples of beam management procedures may differ from what is described with respect to FIG. 4. For example, the UE 120 and the network node 110 may perform the third beam management procedure before performing the second beam management procedure, or the UE 120 and the network node 110 may perform a similar beam management procedure to select a UE transmit beam.

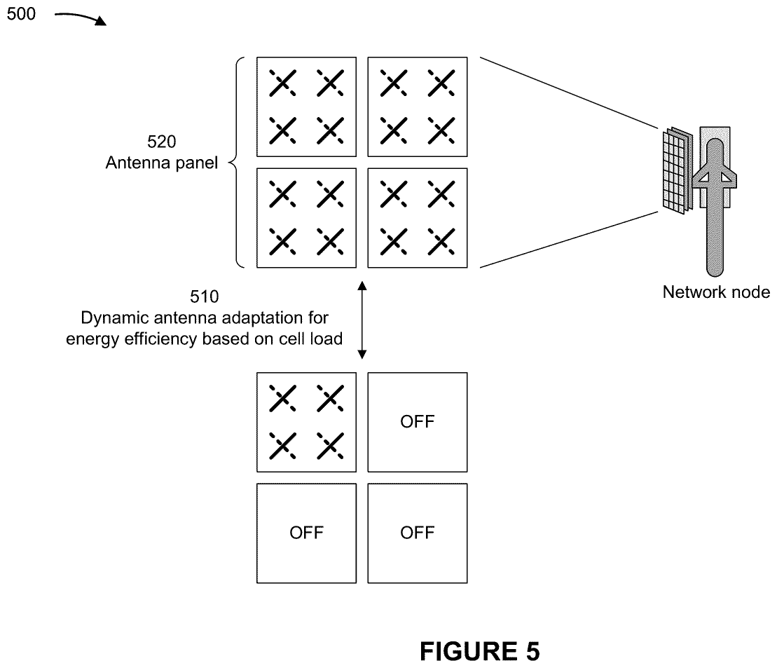

FIG. 5 is a diagram illustrating an example 500 of dynamic network-side antenna adaptation in accordance with the present disclosure. For various reasons, including climate change mitigation, environmental sustainability, and network cost reduction, network energy saving or network energy efficiency measures are expected to have increased importance in wireless network operations. For example, although NR generally offers a significant energy efficiency improvement per gigabyte over previous generations (for example, LTE), new NR use cases or the adoption of millimeter wave frequencies may require more network sites, more network antennas, larger bandwidths, or more frequency bands, which could potentially lead to more efficient wireless networks that nonetheless have higher energy requirements or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity consumption). The largest proportion of energy consumption or energy costs are associated with a RAN, which accounts for about half of the energy consumption in a wireless network, with data centers and fiber transport accounting for smaller shares. Accordingly, measures to increase network energy savings or improve network energy efficiency are important factors that may drive adoption or expansion of wireless networks.

One way to increase energy efficiency in a RAN may be to use dynamic antenna adaptation (sometimes referred to as spatial adaptation) in a network node that communicates using massive MIMO technology, which tends to consume significant power. For example, in an LTE network, a network node that supports massive MIMO technology may communicate using a baseband unit (BBU) (for example, a DU or a CU) that processes baseband signals and communicates with a core network through a physical interface and a remote radio unit (RRU) (for example, an RU or a DU) that performs transmit and receive radio frequency (RF) functions. In an LTE network, the per-cell power consumption (for example, in watts) is slightly larger for the RRU as compared to the BBU, and the per-cell power consumption does not vary significantly with cell load. In an NR network, however, a network node that supports massive MIMO technology may communicate using a BBU and an active antenna unit (AAU) that consumes significantly more power than the BBU and the RRU associated with a network node in an LTE network (for example, because NR operates at a higher data rate or a higher bandwidth than LTE).

For example, in an NR network, the BBU and the AAU of a network node may consume 2.4 times the power of the BBU and RRU in an LTE network node when the cell load is low (for example, 0%), 2.6 times the power of the BBU and RRU in an LTE network node when the cell load is moderate (for example, 50%), or 5 times the power of the BBU and RRU in an LTE network node when the cell load is high (for example, 100%), where “cell load” in this context generally refers to the proportion of frequency resources within a carrier that are being utilized at a given time. Furthermore, in an NR network node, the AAU generally consumes significantly more power than the BBU, and the proportion of power consumption attributable to the AAU increases as the cell loading increases (for example, because the BBU has a relatively static power consumption regardless of cell loading, but the power consumption of the AAU increases when the cell loading increases). Accordingly, because the AAU represents the most power-hungry component in an NR network node that supports massive MIMO technology, improving energy efficiency of the AAU can have a significant impact on overall network energy consumption.

Accordingly, as shown in FIG. 5, in an operation 510, a network node that supports massive MIMO communication may enable dynamic antenna adaptation based on, or otherwise associated with, a current or predicted cell load in order to improve energy efficiency. For example, to enable massive MIMO communication, a network node may generally need to have multiple co-located antenna panels that each include multiple antenna ports. For example, FIG. 5 shows an example antenna panel 520 that includes four sub-panels, and each sub-panel includes several antenna ports (shown as dashed and solid intersecting lines) that each map to one or more physical antennas. For example, in FIG. 5, each diagonal line included in the antenna panel 520 corresponds to one antenna port and the diagonal line represents a polarization of the antenna port (for example, solid diagonal lines may correspond to antenna ports with a horizontal polarization and dashed diagonal lines may correspond to antenna ports with a vertical polarization, or vice versa). In general, each antenna panel 520 is equipped with various power amplifiers and an antenna subsystem, which consume significant power. Accordingly, in order to save power or otherwise utilize energy more efficiently, the network node may dynamically adapt an antenna configuration based on or otherwise associated with a current or predicted cell load. For example, when the cell load is low or predicted to be low, the network node may turn one or more antenna panels, sub-panels, transceiver units (TxRUs), or antenna ports off to reduce energy consumption, and the network node may turn most or all antenna panels, sub-panels, TxRUs, or antenna ports on to increase capacity when the cell load is high or predicted to be high. Indications related to spatial adaptation may help UEs to adapt a CSI-RS configuration to dynamic or semi-persistent activation or deactivation of CSI-RS, or to reconfigure the CSI-RS configuration with respect to an adapted number of spatial elements or ports. A network entity may dynamically select CSI report configurations via a selected triggering state (e.g., CSI-AperiodicTriggerStateList, CSI-SemiPersistentOnPUSCH-TriggerStateList), such as by a medium access control control element (MAC CE) or downlink control information (DCI).

Power control offsets may be used to adapt a transmit power for CSI-RSs. In a first step, CSI feedback may be provided for adaptation of power offset values. In a second step, a PDSCH may be transmitted with a suitable power offset configuration.

Changing the number of active spatial elements (for example antenna ports, active transceiver chains) at the network node impacts shapes of transmit or receive beams at the network node, especially at higher frequency bands (such as FR2 or higher) where communication relies on analog beamforming. For example, when the number of active transceiver chains at the network node increases, more physical antennas will be active for beamforming, making the transmit beams or receive beams at the network node narrower. On the other hand, when the number of active transceiver chains at the network node decreases, fewer physical antennas will be active for beamforming, making the transmit or receive beams at the network node wider.

The beam shape impacts the number of beams (and in effect, the number of CSI-RS resources per set) that the network node should use for CSI-RS transmission to support transmit beam refinement (P2 CSI-RS beam management) and receive beam refinement (P3 CSI-RS beam management) at the UE 120. In particular, for a given beam in P1 CSI-RS beam management (which may carry an SSB), the network node may use a smaller number of CSI-RS resources per CSI-RS resource set for P2 or P3 beam management in the case when the number of active spatial elements is relatively small, than the case when the number of active spatial elements is relatively large.

CSI-RS resources per CSI-RS resource set for beam management may be RRC configured to the UE 120 as part of a CSI-RS resource set's configuration (via NZP-CSI-RS-ResourceSet). Furthermore, the UE 120 may be RRC configured with one or more CSI report configurations, each of which may include CSI-RS resources per CSI-RS resource set (by indicating one or more CSI-RS resource sets, including the CSI-RS resources, that correspond to each CSI report configuration) and the associated CSI-RS antenna port configuration. The numbers of CSI-RS resources per CSI-RS resource set in different CSI report configurations might be different, such as by configuring different CSI report configurations to point to different CSI-RS resource sets which are associated with different numbers of CSI-RS resources. When multiple CSI report configurations are configured, the network node may dynamically select one or more of the configured CSI report configurations for CSI measurement, reporting, and/or beam management.

As mentioned, a CSI report configuration may indicate one or more CSI-RS resource sets. These CSI-RS resource sets may be associated with different numbers of CSI-RS resources. In some aspects, a number of CSI-RS resources belonging to a CSI-RS resource set indicated by a CSI report configuration may be referred to as a “sub-configuration.” A sub-configuration may correspond to a spatial adaptation pattern, such as a dynamic antenna adaptation configuration. By indicating different sub-configurations (different numbers of CSI-RS resources per set), the network can adapt the UE's operation according to the number of antennas or sub-panels active at the gNB.

However, the number of CSI-RS resources per CSI-RS resource set for each CSI report configuration may be blindly selected by the network node without knowledge of how many CSI-RS resources may be sufficient for the UE to perform receive beam refinement (P3 CSI-RS beam management). As the number of active spatial elements changes, a single semi-static configuration of CSI-RS resources (corresponding to a single number of transmit beams at the network node for a given CSI-RS resource set) may lead to inefficient beam sweeping, such as by using an unnecessarily large number of beams, or low beamforming gain, such as by using a relatively wider beam after a number of spatial elements are deactivated.

Some techniques described herein provide for the UE to report a set of candidate values for the total number of CSI-RS resources per CSI-RS resource set. Thus, the network node can configure multiple CSI report configurations, which may point to different CSI-RS resource sets, with the number of CSI-RS resources per CSI-RS resource set (e.g., a sub-configuration, a size of a sub-configuration, a number of CSI-RS resources in a sub-configuration) being based on or otherwise associated with the set of candidate values reported by the UE. Thus, the network node can properly plan beams for transmit beam refinement or receive beam refinement. For example, if the network node has knowledge of the UE's receive beam sweeping (such as according to a reported set of candidate values for the total number of CSI-RS resources per CSI-RS resource set), the network node may configure CSI-RS resources accordingly. In this example, the network node may configure, for UE receive beam sweeping, 8 CSI-RS resources per set for when the UE uses 8 antenna elements, 5 CSI-RS resources per set for when the UE uses 4 antenna elements, and 3 CSI-RS resources per set for when the UE uses 2 antenna elements. Furthermore, the UE can save measurement overhead if the configured CSI-RS resources for beam measurements are reduced when the number of spatial elements used to transmit the CSI-RS decreases.

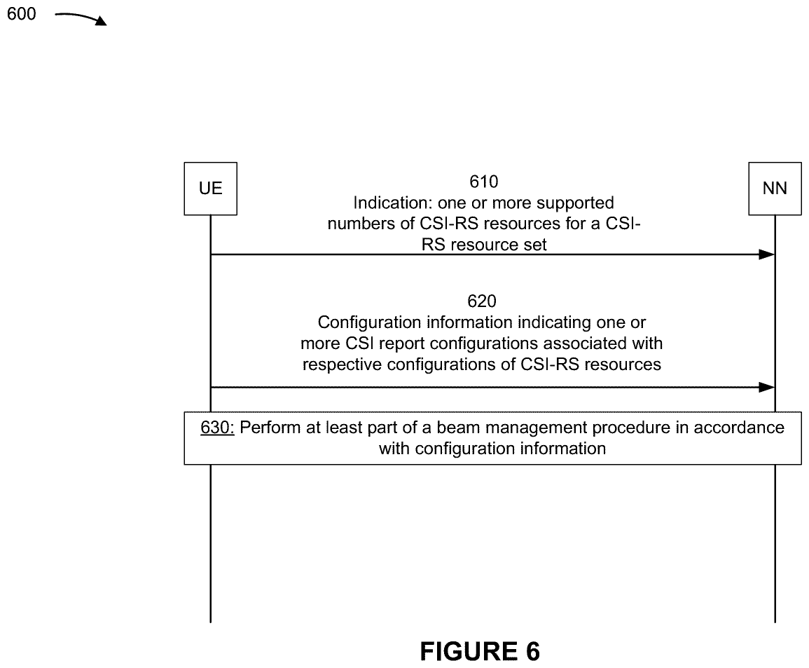

FIG. 6 is a diagram illustrating an example 600 of signaling for CSI report configuration with dynamic antenna adaptation, in accordance with the present disclosure. Example 600 includes a UE (such as UE 120) and a network node (such as network node 110). The network node may be capable of performing dynamic antenna adaptation, such as by activating or deactivating transceivers or spatial elements. In some aspects, operations of example 600, described as being performed by the network node, may be performed by another network node associated with the network node. For example, “transmitting a reference signal” may include the network node transmitting the reference signal itself, or may include the network node triggering or configuring transmission of the reference signal by another network node (such as a DU or RU).

As shown, the UE may transmit and the network node may receive information 610. The information 610 may indicate one or more supported numbers of CSI-RS resources for a CSI-RS resource set (that is, per CSI-RS resource set) (such as one or more supported sub-configurations). For example, the UE may report a set of supported candidate values (for example, a set of supported numbers) for a total number of CSI-RS resources per set for a CSI-RS resource set. In some aspects, the one or more supported numbers may apply to a CSI-RS resource set for which CSI-RS resources are associated with repetition. For example, the set of supported candidate values may be for a CSI-RS resource set configured with repetition set to “on.” The UE may transmit the information 610 as part of UE capability reporting or RRC connection setup.

Each number of CSI-RS resources (in other words, each candidate value or sub-configuration) may correspond to a total number of candidate beams for a receive beam sweep, assuming that a subset of spatial elements are used per UE panel. As an illustrative example, the one or more supported numbers of CSI-RS resources per CSI-RS resource set may include [8 5 3] corresponding to a number of active antenna elements, at the UE, of [8 4 2]. This indicates that the network node can configure three CSI-RS resource sets that include 8, 5, and 3 CSI-RS resources, to facilitate the UE's measurement of CSI-RS when different numbers of antenna elements are active at the UE. In some aspects, the UE may not report the number of active antenna elements described above (for example, the UE may only report the one or more supported numbers of CSI-RS resources). The supported number of CSI-RS resources may indicate how many repetitions of the CSI-RS resource are transmitted for a receive beam sweep.

As shown, the network node may transmit (directly or via another network node), and the UE may receive, configuration information 620. The configuration information 620 may include one or more RRC messages, one or more RRC information elements (IEs), or a combination thereof.

In some aspects, the configuration information 620 may include one or more CSI-RS report configurations. For example, each CSI-RS report configuration, of the one or more CSI-RS report configurations, may be associated with a respective configuration of CSI-RS resources (such as one or more CSI-RS resource sets that indicate the configuration of CSI-RS resources). Continuing the above example in which the UE reports supported numbers of CSI-RS resources per CSI-RS resource set of [8 5 3] in the information 610, a first CSI-RS report configuration may be configured with (such as by indicating a CSI-RS resource set with) 8 CSI-RS resources per CSI-RS resource set, a second CSI-RS report configuration may be configured with (such as by indicating a CSI-RS resource set with) 5 CSI-RS resources per CSI-RS resource set, and a third CSI-RS report configuration may be configured with (such as by indicating a CSI-RS resource set with) 3 CSI-RS resources per CSI-RS resource set. Thus, the CSI-RS report configurations may include maximum numbers of CSI-RS resources per CSI-RS resource set that match the reported numbers of CSI-RS resources per CSI-RS resource set. Each of these CSI-RS resources (or the corresponding CSI-RS resource set) may be configured with repetition, such that the CSI-RS report configurations can be used for beam management at the UE. The CSI-RS report configurations, indicating the different numbers of CSI-RS resources per CSI-RS resource set, may be referred to as configurations of CSI-RS resources. Additionally, or alternatively, the different CSI-RS resource sets configured with the different numbers of CSI-RS resource per CSI-RS resource set may be referred to as configurations of CSI-RS resources. The different numbers of CSI-RS resources per CSI-RS resource set can be implemented using different CSI-RS resource set configurations (NZP-CSI-RS-ResourceSet), using different CSI-RS report configurations (CSI-ReportConfig), using different CSI-RS resource configurations, or a combination thereof.

In some aspects, the configuration information 620 may indicate a mapping between a CSI-RS report configuration for beam management and a CSI-RS report configuration for CSI measurement. A CSI-RS report configuration for beam management may define how the UE performs one or more of P2 CSI-RS beam management or P3 CSI-RS beam management, by defining which CSI-RS resources are measured for the beam management. For example, the CSI-RS report configurations described above as being provided in the configuration information 620 may include CSI-RS report configurations for beam management. A CSI-RS report configuration for beam management may include a report quantity (reportQuantity) set to a value cri-RSRP or ss-Index-RSRP. A CSI-RS report configuration for CSI measurement may define how the UE is to measure and report CSI, such as a channel quality indicator (CQI), a rank indicator, or a precoding matrix indicator. A CSI-RS report configuration for CSI measurement may include a report quantity (reportQuantity) set to a value cri-RI-PMI-CQI, cri-RI-i1, or cri-RI-i1-CQI. As part of a CSI report configuration for CSI measurement, multiple codebook configurations associated with different spatial element (such as CSI-RS antenna port) configurations may be configured for CSI measurement (CQI, rank indicator (RI), or precoding matrix indicator (PMI)). The network node can dynamically (via downlink control information or MAC signaling) indicate a selected codebook configuration for the UE (such as by indicating a corresponding CSI report configuration). The UE may then use a configuration of CSI-RS resources, associated with the indicated codebook configuration, for CSI measurement. As mentioned, the configuration information 620 may indicate a mapping between a CSI-RS report configuration for beam management (sometimes referred to as a first configuration) and a CSI-RS report configuration for CSI measurement (sometimes referred to as a second configuration). The mapping can be one-to-one (such that a single first configuration is mapped to a single second configuration), many-to-one (such that two or more first configurations are mapped to a single second configuration), or one-to-many (such that a single first configuration is mapped to two or more second configurations). In some aspects, the mapping may be defined by a wireless communication specification. Description of how the UE performs beam management according to the mapping is provided below in connection with beam management 630.

As shown, the UE may perform beam management 630 in accordance with the configuration information 620. In some aspects, the UE may measure a set of CSI-RS resources indicated by a selected configuration of the one or more configurations of CSI-RS resources provided in the configuration information 620. For example, the UE may measure the set of CSI-RS resources according to a selected CSI-RS report configuration, of one or more CSI-RS report configurations provided in the configuration information 620, where the selected CSI-RS report configuration indicates the set of CSI-RS resources via one or more CSI-RS resource sets. In some aspects, the network node may output, and the UE may receive, dynamic signaling (for example, downlink control information or MAC signaling) indicating the selected CSI-RS report configuration. In some aspects, the network node may select the selected CSI-RS report configuration based on or otherwise associated with a number of active spatial elements at the network node. For example, the network node may select a CSI-RS report configuration that is configured with a number of CSI-RS resources (corresponding to a number of beams) that are sufficient for the UE to perform P3 CSI-RS beam refinement based on or otherwise associated with an antenna configuration of the network node, an antenna configuration of the UE, or a combination thereof.

In some aspects, the UE may identify a selected configuration, of the CSI-RS report configurations (or the corresponding CSI-RS resource configurations) according to a mapping between CSI-RS report configurations for beam management (for example, first configurations) and CSI-RS report configurations for CSI measurement (for example, second configurations). For example, if the network node dynamically adapts the number of spatial elements used to transmit CSI-RS, the network node may need to dynamically switch between different CSI-RS resource configurations (and/or different CSI-RS report configurations) frequently. This may cause overhead and power consumption if the network node dynamically signals a different CSI-RS report configuration for beam management each time the network node changes the number of spatial elements. By using a mapping from a second configuration to a first configuration, the network node can reduce overhead and power consumption. For example, the network node may transmit, and the UE may receive, signaling indicating a second configuration or one or more parameters of a second configuration for CSI measurement, such as a CSI-RS antenna port configuration or a codebook configuration. The UE may identify a first configuration (for example, a CSI-RS report configuration) that is mapped to the second configuration indicated by the signaling, and may perform beam management by performing CSI-RS resources according to the first configuration.

As an example, the network node may perform dynamic antenna adaptation between two antenna port configurations for CSI measurements and two CSI-RS resource sets with resources configured with repetition set to “on” (that is, two CSI-RS associated with CSI for beam management). The UE may perform beam management according to a CSI report configuration having a CSI-RS resource set with CSI-RS resources configured with repetition set to “on” having 8 CSI-RS resources per set when the CSI-RS report configuration with a codebook having a 32-CSI-RS antenna port configuration is selected for CSI measurement. The UE may perform beam management according to a CSI report configuration having a CSI-RS resource set with CSI-RS resources configured with repetition set to “on” having 5 CSI-RS resources per CSI-RS resource set when the CSI-RS report configuration with a codebook having a 16-CSI-RS antenna port configuration is selected for CSI measurement. Thus, overhead and power consumption at the network node is reduced, by signaling a codebook or configuration for CSI measurement and implicitly deriving the CSI report configuration for beam management from the codebook or configuration.

FIG. 7 is a flowchart illustrating an example process 700 performed, for example, by a UE that supports CSI reporting in accordance with the present disclosure. Example process 700 is an example where the UE (for example, UE 120) performs operations associated with beam management using multiple CSI-RS resource configurations.

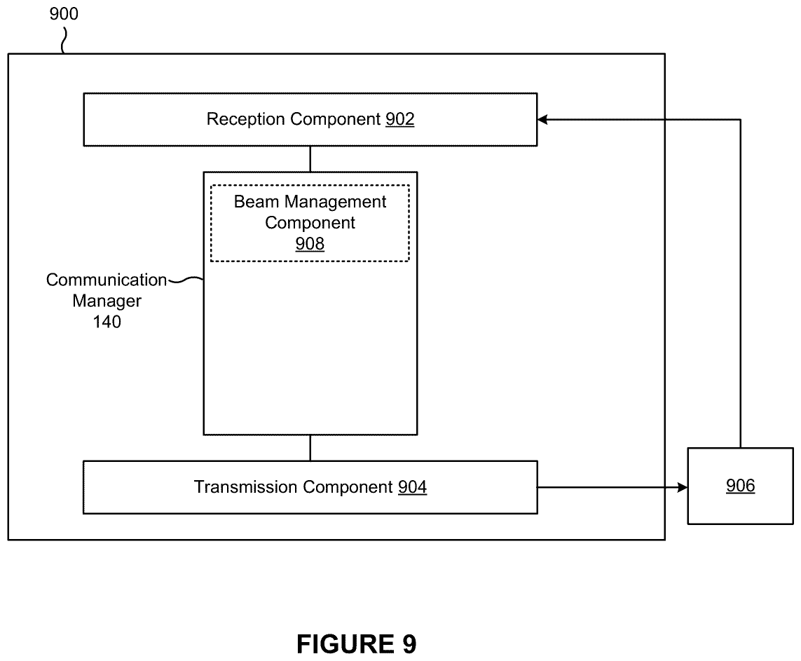

As shown in FIG. 7, in some aspects, process 700 may include transmitting information indicating one or more supported numbers of CSI-RS resources per CSI-RS resource set (block 710). For example, the UE (such as by using communication manager 140 or transmission component 904, depicted in FIG. 9) may transmit information indicating one or more supported numbers of CSI-RS resources per CSI-RS resource set, as described above in connection with the information 610 of FIG. 6.

As further shown in FIG. 7, in some aspects, process 700 may include receiving configuration information indicating one or more configurations of CSI-RS resources for one or more CSI-RS resource sets, wherein each configuration of the one or more configurations includes a respective number of CSI-RS resources indicated by the one or more supported numbers of CSI-RS resources (block 720). For example, the UE (such as by using communication manager 140 or reception component 902, depicted in FIG. 9) may receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources, as described above in connection with the configuration information 620 of FIG. 6. In some aspects, the one or more configurations may be one or more CSI-RS report configurations, where each CSI-RS report configuration is configured with a CSI-RS resource set including a number of CSI-RS resources indicated by the one or more supported numbers. In some aspects, the one or more configurations may be one or more CSI-RS resource sets, each CSI-RS resource set including a number of CSI-RS resources indicated by the one or more supported numbers.

As further shown in FIG. 7, in some aspects, process 700 may include performing at least part of a beam management procedure in accordance with the configuration information (block 730). For example, the UE (such as by using communication manager 140 or beam management component 908, depicted in FIG. 9) may measure a CSI-RS in accordance with the configuration information, as described above in connection with beam management 630 of FIG. 6. At the UE, performing at least part of the beam management procedure may include measuring CSI-RS in accordance with the configuration information (on CSI-RS resources indicated by the configuration information). For example, the UE may receive a CSI-RS on a set of CSI-RS resources indicated by a CSI-RS resource set corresponding to an indicated CSI-RS report configuration using two or more different spatial reception filters.

Process 700 may include additional aspects, such as any single aspect or any combination of aspects described below or in connection with one or more other processes described elsewhere herein.

In a first additional aspect, the configuration information is associated with repetition of CSI-RS resources.

In a second additional aspect, alone or in combination with the first aspect, process 700 includes receiving signaling indicating a selected configuration of the one or more configurations, wherein performing at least part of the beam management procedure is in accordance with the selected configuration.

In a third additional aspect, alone or in combination with one or more of the first and second aspects, the selected configuration is a first configuration for beam management, and the signaling indicates a second configuration for CSI measurement that is mapped to the first configuration.

In a fourth additional aspect, alone or in combination with one or more of the first through third aspects, the selected configuration is mapped only to the second configuration.

In a fifth additional aspect, alone or in combination with one or more of the first through fourth aspects, the selected configuration is mapped to the second configuration and another configuration for CSI measurement.

In a sixth additional aspect, alone or in combination with one or more of the first through fifth aspects, the one or more configurations include multiple configurations, and the second configuration is mapped to the multiple configurations.

In a seventh additional aspect, alone or in combination with one or more of the first through sixth aspects, process 700 includes receiving information indicating a mapping between the selected configuration and the second configuration.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, by a network node that supports CSI configuration in accordance with the present disclosure. Example process 800 is an example where the network node (for example, network node 110) performs operations associated with beam management using multiple CSI-RS resource configurations.

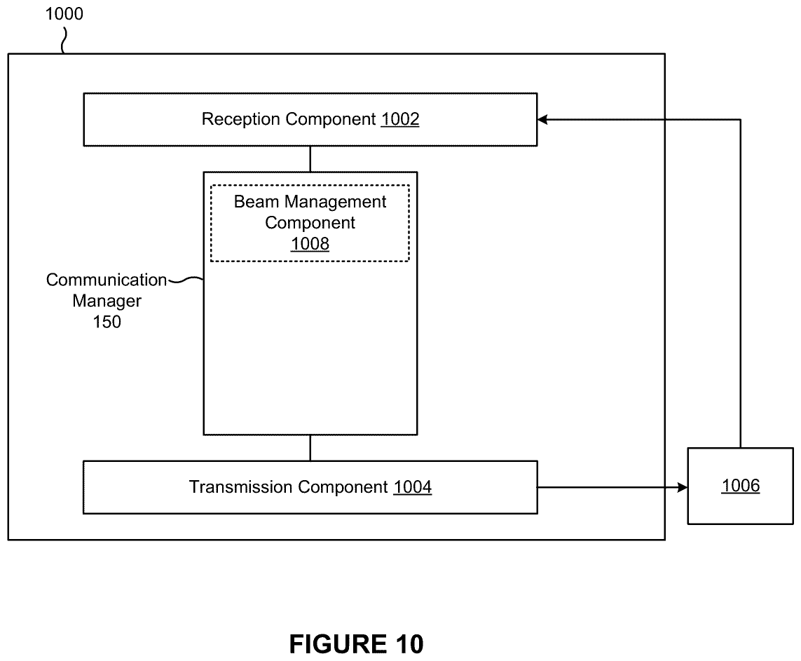

As shown in FIG. 8, in some aspects, process 800 may include receiving information indicating one or more supported numbers of CSI-RS resources per CSI-RS resource set for a UE (block 810). For example, the network node (such as by using communication manager 150 or reception component 1002, depicted in FIG. 10) may receive information indicating one or more supported numbers of CSI-RS resources per CSI-RS resource set for a UE, as described above.

As further shown in FIG. 8, in some aspects, process 800 may include transmitting configuration information indicating one or more configurations of CSI-RS resources for one or more CSI-RS resource sets, wherein each configuration of the one or more configurations includes a respective number of CSI-RS resources indicated by the one or more supported numbers of CSI-RS resources (block 820). For example, the network node (such as by using communication manager 150 or transmission component 1004, depicted in FIG. 10) may transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources, as described above.

As further shown in FIG. 8, in some aspects, process 800 may include performing at least part of a beam management procedure in accordance with the configuration information (block 830). For example, the network node (such as by using communication manager 150 or beam management component 1008, depicted in FIG. 10) may perform at least part of a beam management procedure in accordance with the configuration information, as described above. At the network node, performing at least part of the beam management procedure may include transmitting CSI-RS in accordance with the configuration information (on CSI-RS resources indicated by the configuration information).

Process 800 may include additional aspects, such as any single aspect or any combination of aspects described below or in connection with one or more other processes described elsewhere herein.

In a first additional aspect, the configuration information is associated with repetition of CSI-RS resources the CSI-RS resource set.

In a second additional aspect, alone or in combination with the first aspect, process 800 includes transmitting signaling indicating a selected configuration of the one or more configurations, wherein performing at least part of the beam management procedure is in accordance with the selected configuration.

In a third additional aspect, alone or in combination with one or more of the first and second aspects, the selected configuration is a first configuration for beam management, and the signaling indicates a second configuration for CSI measurement that is mapped to the first configuration.

In a fourth additional aspect, alone or in combination with one or more of the first through third aspects, the selected configuration is mapped only to the second configuration.

In a fifth additional aspect, alone or in combination with one or more of the first through fourth aspects, the selected configuration is mapped to the second configuration and another configuration for CSI measurement.

In a sixth additional aspect, alone or in combination with one or more of the first through fifth aspects, the one or more configurations include multiple configurations, and the second configuration is mapped to the multiple configurations.

In a seventh additional aspect, alone or in combination with one or more of the first through sixth aspects, process 800 includes transmitting information indicating a mapping between the selected configuration and the second configuration.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports beam management in accordance with the present disclosure. The apparatus 900 may be a UE, or a UE may include the apparatus 900. In some aspects, the apparatus 900 includes a reception component 902, a transmission component 904, and a communication manager 140, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to or operable to perform one or more operations described herein in connection with FIGS. 4-6. Additionally or alternatively, the apparatus 900 may be configured to, or operable to, perform one or more processes described herein, such as process 700 of FIG. 7. In some aspects, the apparatus 900 may include one or more components of the UE described above in connection with FIG. 2.

The reception component 902 may receive communications, such as reference signals, control information, or data communications, from the apparatus 906. The reception component 902 may provide received communications to one or more other components of the apparatus 900, such as the communication manager 140. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, or a memory of the UE described above in connection with FIG. 2.

The transmission component 904 may transmit communications, such as reference signals, control information, or data communications, to the apparatus 906. In some aspects, the communication manager 140 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, or a memory of the UE described above in connection with FIG. 2. In some aspects, the transmission component 904 may be co-located with the reception component 902 in a transceiver.

The communication manager 140 may transmit or may cause the transmission component 904 to transmit information indicating one or more supported numbers of channel state information reference signal (CSI-RS) resources per CSI-RS resource set. The communication manager 140 may receive or may cause the reception component 902 to receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The communication manager 140 may measure a CSI-RS in accordance with the configuration information. In some aspects, the communication manager 140 may perform one or more operations described elsewhere herein as being performed by one or more components of the communication manager 140.

The communication manager 140 may include a controller/processor, a memory, a scheduler, or a communication unit of the UE described above in connection with FIG. 2. In some aspects, the communication manager 140 includes a set of components, such as a beam management component 908. Alternatively, the set of components may be separate and distinct from the communication manager 140. In some aspects, one or more components of the set of components may include or may be implemented within a controller/processor or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 904 may transmit information indicating one or more supported numbers of CSI-RS resources per CSI-RS resource set. The reception component 902 may receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The beam management component 908 may measure a CSI-RS in accordance with the configuration information.

The reception component 902 may receive signaling indicating a selected configuration of the one or more configurations, wherein performing at least part of the beam management procedure is in accordance with the selected configuration.

The reception component 902 may receive information indicating a mapping between the selected configuration and the second configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports CSI transmission in accordance with the present disclosure. The apparatus 1000 may be a network node, or a network node may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to or operable to perform one or more operations described herein in connection with FIGS. 4-6. Additionally or alternatively, the apparatus 1000 may be configured to or operable to perform one or more processes described herein, such as process 800 of FIG. 8. In some aspects, the apparatus 1000 may include one or more components of the network node described above in connection with FIG. 2.

The reception component 1002 may receive communications, such as reference signals, control information, or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a modem, a demodulator, a MIMO detector, a receive processor, a controller/processor, or a memory of the network node described above in connection with FIG. 2.

The transmission component 1004 may transmit communications, such as reference signals, control information, or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, or a memory of the network node described above in connection with FIG. 2. In some aspects, the transmission component 1004 may be co-located with the reception component 1002 in a transceiver.

The communication manager 150 may receive or may cause the reception component 1002 to receive information indicating one or more supported numbers of CSI-RS resources per CSI-RS resource set for a UE. The communication manager 150 may transmit or may cause the transmission component 1004 to transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The communication manager 150 may perform at least part of a beam management procedure in accordance with the configuration information. In some aspects, the communication manager 150 may perform one or more operations described elsewhere herein as being performed by one or more components of the communication manager 150.

The communication manager 150 may include a controller/processor, a memory, a scheduler, or a communication unit of the network node described above in connection with FIG. 2. In some aspects, the communication manager 150 includes a set of components, such as a beam management component 1008. Alternatively, the set of components may be separate and distinct from the communication manager 150. In some aspects, one or more components of the set of components may include or may be implemented within a controller/processor, a memory, a scheduler, or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive information indicating one or more supported numbers of CSI-RS resources per CSI-RS resource set for a UE. The transmission component 1004 may transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources. The beam management component 1008 may measure a CSI-RS in accordance with the configuration information.

The transmission component 1004 may transmit signaling indicating a selected configuration of the one or more configurations, wherein performing at least part of the beam management procedure is in accordance with the selected configuration.

The transmission component 1004 may transmit information indicating a mapping between the selected configuration and the second configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting information indicating one or more supported numbers of channel state information reference signal (CSI-RS) resources per CSI-RS resource set; receiving configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and measuring a CSI-RS in accordance with the configuration information.

Aspect 2: The method of Aspect 1, wherein the configuration information is associated with repetition of CSI-RS resources of the CSI-RS resource set.

Aspect 3: The method of any of Aspects 1-2, further comprising receiving signaling indicating a selected configuration of the one or more configurations, wherein measuring the CSI-RS is in accordance with the selected configuration.

Aspect 4: The method of Aspect 3, wherein the selected configuration is a first configuration for beam management, and wherein the signaling indicates a second configuration for channel state information (CSI) measurement that is mapped to the first configuration.

Aspect 5: The method of Aspect 4, wherein the selected configuration is mapped to the second configuration.

Aspect 6: The method of Aspect 4, wherein the selected configuration is mapped to the second configuration and another configuration for CSI measurement.

Aspect 7: The method of Aspect 4, wherein the one or more configurations include multiple configurations, and wherein the second configuration is mapped to the multiple configurations.

Aspect 8: The method of Aspect 4, further comprising receiving information indicating a mapping between the selected configuration and the second configuration.

Aspect 9: A method of wireless communication performed by a network node, comprising: receiving information indicating one or more supported numbers of channel state information reference signal (CSI-RS) resources per CSI-RS resource set for a user equipment (UE); transmitting configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and transmitting a CSI-RS in accordance with the configuration information.

Aspect 10: The method of Aspect 9, wherein the configuration information is associated with repetition of CSI-RS resources.

Aspect 11: The method of any of Aspects 9-10, further comprising transmitting signaling indicating a selected configuration of the one or more configurations, wherein performing at least part of the beam management procedure is in accordance with the selected configuration.

Aspect 12: The method of Aspect 11, wherein the selected configuration is a first configuration for beam management, and wherein the signaling indicates a second configuration for channel state information (CSI) measurement that is mapped to the first configuration.

Aspect 13: The method of Aspect 12, wherein the selected configuration is mapped only to the second configuration.

Aspect 14: The method of Aspect 12, wherein the selected configuration is mapped to the second configuration and another configuration for CSI measurement.

Aspect 15: The method of Aspect 12, wherein the one or more configurations include multiple configurations, and wherein the second configuration is mapped to the multiple configurations.

Aspect 16: The method of Aspect 12, further comprising transmitting information indicating a mapping between the selected configuration and the second configuration.

Aspect 17: The method of Aspect 2, wherein transmitting the CSI-RS comprises transmitting the CSI-RS on a set of CSI-RS resources using two or more different spatial transmission filters.

Aspect 18: The method of Aspect 9, wherein performing at least part of the beam management procedure further comprises transmitting repetitions of a CSI-RS using a same spatial transmission filter.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor operable to cause the UE to:
transmit information indicating one or more supported numbers of channel state information reference signal (CSI-RS) resources per CSI-RS resource set;
receive configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and
measure a CSI-RS in accordance with the configuration information.

2. The UE of claim 1, wherein the configuration information is associated with repetition of CSI-RS resources.

3. The UE of claim 2, wherein the at least one processor, to cause the UE to measure the CSI-RS, is operable to cause the UE to receive the CSI-RS on a set of CSI-RS resources using two or more different spatial reception filters.

4. The UE of claim 1, wherein the at least one processor is further operable to cause the UE to receive signaling indicating a selected configuration of the one or more configurations, wherein measuring the CSI-RS is in accordance with the selected configuration.

5. The UE of claim 4, wherein the selected configuration is a first configuration for beam management, and wherein the signaling indicates a second configuration for channel state information (CSI) measurement that is mapped to the first configuration.

6. The UE of claim 5, wherein the selected configuration is mapped to the second configuration.

7. The UE of claim 5, wherein the selected configuration is mapped to the second configuration and another configuration for CSI measurement.

8. The UE of claim 5, wherein the one or more configurations include multiple configurations, and wherein the second configuration is mapped to the multiple configurations.

9. The UE of claim 5, wherein the at least one processor is further operable to cause the UE to receive information indicating a mapping between the selected configuration and the second configuration.

10. A network node for wireless communication, comprising:
at least one memory; and
at least one processor communicatively coupled with the at least one memory, the at least one processor operable to cause the network node to:
receive information indicating one or more supported numbers of channel state information reference signal (CSI-RS) resources per CSI-RS resource set for a user equipment (UE);
transmit configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and
transmit a CSI-RS in accordance with the configuration information.

11. The network node of claim 10, wherein the configuration information is associated with repetition of CSI-RS resources of the one or more CSI-RS resource sets.

12. The network node of claim 11, wherein the at least one processor, to cause the UE to transmit the CSI-RS, is operable to cause the UE to transmit repetitions of a CSI-RS using a same spatial transmission filter.

13. The network node of claim 10, wherein the at least one processor is further operable to cause the network node to transmit signaling indicating a selected configuration of the one or more configurations, wherein transmitting the CSI-RS is in accordance with the selected configuration.

14. The network node of claim 13, wherein the selected configuration is a first configuration for beam management, and wherein the signaling indicates a second configuration for channel state information (CSI) measurement that is mapped to the first configuration.

15. The network node of claim 14, wherein the selected configuration is mapped only to the second configuration.

16. The network node of claim 14, wherein the selected configuration is mapped to the second configuration and another configuration for CSI measurement.

17. The network node of claim 14, wherein the one or more configurations include multiple configurations, and wherein the second configuration is mapped to the multiple configurations.

18. The network node of claim 14, wherein the at least one processor is further operable to cause the network node to transmit information indicating a mapping between the selected configuration and the second configuration.

19. A method of wireless communication performed by a user equipment (UE), comprising:
transmitting information indicating one or more supported numbers of channel state information reference signal (CSI-RS) resources per CSI-RS resource set;
receiving configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and
measuring a CSI-RS in accordance with the configuration information.

20. The method of claim 19, wherein the configuration information is associated with repetition of CSI-RS resources.

21. The method of claim 19, further comprising receiving signaling indicating a selected configuration of the one or more configurations, wherein measuring the CSI-RS is in accordance with the selected configuration.

22. The method of claim 21, wherein the selected configuration is a first configuration for beam management, and wherein the signaling indicates a second configuration for channel state information (CSI) measurement that is mapped to the first configuration.

23. The method of claim 22, wherein the selected configuration is mapped only to the second configuration.

24. The method of claim 22, further comprising receiving information indicating a mapping between the selected configuration and the second configuration.

25. A method of wireless communication performed by a network node, comprising:
receiving information indicating one or more supported numbers of channel state information reference signal (CSI-RS) resources per CSI-RS resource set for a user equipment (UE);
transmitting configuration information indicating one or more configurations of CSI-RS resources for one or more CSI-RS resource sets, wherein each configuration of the one or more configurations includes a respective number of CSI-RS resources indicated by the one or more supported numbers of CSI-RS resources; and
transmitting a CSI-RS in accordance with the configuration information.

26. The method of claim 25, wherein the configuration information is associated with repetition of CSI-RS resources.

27. The method of claim 25, further comprising transmitting signaling indicating a selected configuration of the one or more configurations, wherein transmitting the CSI-RS is in accordance with the selected configuration.

28. The method of claim 27, wherein the selected configuration is a first configuration for beam management, and wherein the signaling indicates a second configuration for channel state information (CSI) measurement that is mapped to the first configuration.

29. The method of claim 28, wherein the selected configuration is mapped only to the second configuration.

30. The method of claim 28, wherein the selected configuration is mapped to the second configuration and another configuration for CSI measurement.
